(19) United States
(12) Patent Application Publication
(10) Pub. No.: US 2025/0184685 A1
(43) Pub. Date: Jun. 5, 2025

(54) SECURE MONOSTATIC WIRELESS PROXIMITY DETECTION SENSING

(71) Applicant: Intel Corporation, Santa Clara, CA (US)

(72) Inventors: Ofer HAREUVENI, Haifa (IL); Maxim STEPANOV, Jerusalem (IL)

(21) Appl. No.: 18/525,889

(22) Filed: Dec. 1, 2023

(51) Int. Cl. H04W 4/02; H04W 12/03; H04W 12/63; H04W 84/12

(52) U.S. Cl. CPC H04W 4/02; H04W 12/03; H04W 12/63; H04W 84/12

(57) ABSTRACT

Disclosed herein are devices, methods, and systems for wireless proximity detection of an object (e.g., a human user) with respect to a computing system. A proximity detection system may transmit a series of wireless signal frames, each including a signature that differs between consecutive frames of the series of transmitted wireless signal frames. The system may also determine a validated frame subset from among a series of received wireless signal frames based on whether the series of received wireless signal frames includes the signature corresponding to the series of transmitted wireless signal frames. The system may also determine a proximity of an object to a wireless antenna based on the validated frame subset. This signature may be randomized so as to provide improved security against spurious/fraudulently transmitted signal frames.

### TECHNICAL FIELD

The disclosure relates generally to wireless sensing, and in particular, to privacy and security of wireless proximity detection sensing.

### BACKGROUND

Wireless systems are often part of today's computing platforms, regardless of the computing platform's form factor, including, for example, desktop systems, laptops, notebooks, tablets, smartphones, wearables, etc. In addition to wireless communications capabilities that the wireless system provides to the computing platform, the wireless system may also be used to provide proximity detection, motion detection, gesture sensing, localization, and health monitoring capabilities to the computing platform. To provide proximity detection sensing to the computing platform, for example, the wireless system may transmit a signal on one of its antennas and monitor receptions on another of its antennas for a reflection of the transmitted off of a nearby human. The proximity detection system may then analyze the received signal(s) to identify whether the transmitted signal was reflected in such a way so as to indicate that an object (e.g., human body) is near the transmitting antenna. Proximity detection capabilities may coexist with the communication capabilities/wireless networking capabilities provided by the wireless system, meaning that proximity detection may be provided in a way that has a low impact on wireless communication/networking performance and minimal power consumption, without the cost of additional hardware. Nevertheless, such proximity detection may be vulnerable to hacking, where the hacker may be able to transmit signals that disrupt the accuracy of the proximity detection system, making it seem that a human is near the wireless system (when, in fact, a human is not nearby) or making it seem that a human is not near the wireless system (when, in fact, the human is nearby).

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of a monostatic wireless proximity sensing system;

FIG. 2 shows an exemplary attack to a monostatic wireless proximity sensing system;

FIGS. 3A and 3B show frame formats for physical packet data units according to the IEEE 802.11 standard;

FIGS. 4A and 4B show exemplary amplitude measurements plotted across different subcarriers for a static and dynamic environment, respectively;

FIG. 5 shows an exemplary a high level diagram of a computing system with a proximity detection system that may generate frame-by-frame randomized signatures;

FIG. 6 shows an example of a proximity detection system that uses randomizations to generate different preambles for wireless packets;

FIG. 7 shows an exemplary schematic drawing of a device for monostatic wireless proximity sensing; and

FIG. 8 depicts a schematic flow diagram of an exemplary method for monostatic wireless proximity sensing.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

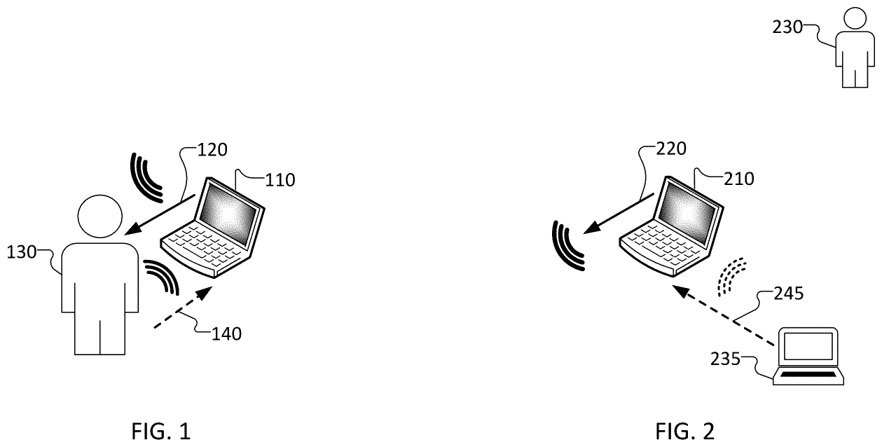

As noted above, wireless systems may be used to provide a form of proximity detection to the computing platform, where the wireless system may transmit a signal on one of its antennas and monitor receptions of the signal on another of its antennas. The proximity detection system may then analyze the received signal(s) to identify whether the transmitted signal was reflected in such a way so as to indicate that a human body is near the transmitting antenna. Where the antenna used for transmission is co-located with the antenna used for reception (e.g., the transmit (TX) and receive (RX) antennas are on the same device), this is often referred to as “monostatic” proximity sensing. This basic concept of monostatic proximity sensing is shown in FIG. 1, where a computing system 110 includes a wireless system that transmits a wireless signal to determine whether an object (e.g., user 130) is within a certain proximity of the computing system 110. Arrow 120 represents the wireless transmission from the computing system 110 that is transmitted in order to detect the proximity of user 130. If user 130 is nearby, the wireless transmission will reflect off of user 130, as shown by arrow 140, and this reflected transmission (e.g., the “echo” of the transmitted signal) may be received by the same wireless system of computing system 110. The computing system 110 may then analyze this received signal (e.g., its magnitude, frequency, bandwidth, or other channel/signal characteristics, etc.) to determine whether the characteristics of the received signal indicate that an object (e.g., user 130) is nearby. For example, the computing system 110 may determine that if the signal strength of the received signal satisfies a predefined criterion (e.g., it is above a predefined threshold), an object (e.g., user 130) is nearby. If the signal strength of the received signal does not satisfy the predefined criterion (e.g., it is below the predefined threshold), an object (e.g., user 130) is not nearby. As should be appreciated, signal strength is a non-limiting example of the channel/signal characteristic the computing system 110 may analyze to determine whether user 130 is proximate to the computing system 110, and any characteristic or characteristics of the received signal(s) may be analyzed to determine the proximity of an object based on a comparison of the transmitted signal(s) to the received signal(s).

Based on the proximity determination of whether (and/or to what extent) the user 130 is proximate to the computing system 110, the computing system 110 may make adjustments to its user interface. For example, if the user 130 walks away from the computing system 110 (e.g., to take a break), the computing system 110 may lock access to the computing system 110 (e.g., by disabling the user interface until a password or biometric data is entered to re-enable the user interface for normal operation of the computing system 110 by user 130). This way, if user 130 forgets to lock access to and/or shutdown the computing system 110 before walking away, the computing system 110 may automatically lock the user interface and/or enter a low-power “sleep” mode when it detects that user 130 has walked away from and is no longer proximate to the computing system 110. When the user 130 is proximate to the computing system 110, the computing system may re-enable the user interface, request a password/biometric data, awake from sleep mode, and/or perform other actions in response to detecting that the user 130 is proximate to the computing system 110.

As noted above, such proximity detection may be vulnerable to hacking, where the hacker may be able to transmit signals that disrupt the accuracy of the proximity detection system, making it seem that an object is proximate, when, in fact, it is not. Or, making it seem that an object is not proximate, when, in fact, it is. In this way, the hacker may attempt, for example, to bypass the additional security provided by proximity detection (e.g., prevent the automatic locking of the user interface or cause premature locking of the user interface). For example, the hacker may transmit wireless signals that effectively cancel the echo signal reflected from user 130 that is proximate to computing system 110 such that the computing system 110 does not detect a transmitted “echo” (arrow 140), meaning that the proximity detection system would be fooled into believing that the user 130 is not actually present and would maliciously cause the user interface to lock or enable the low-power mode.

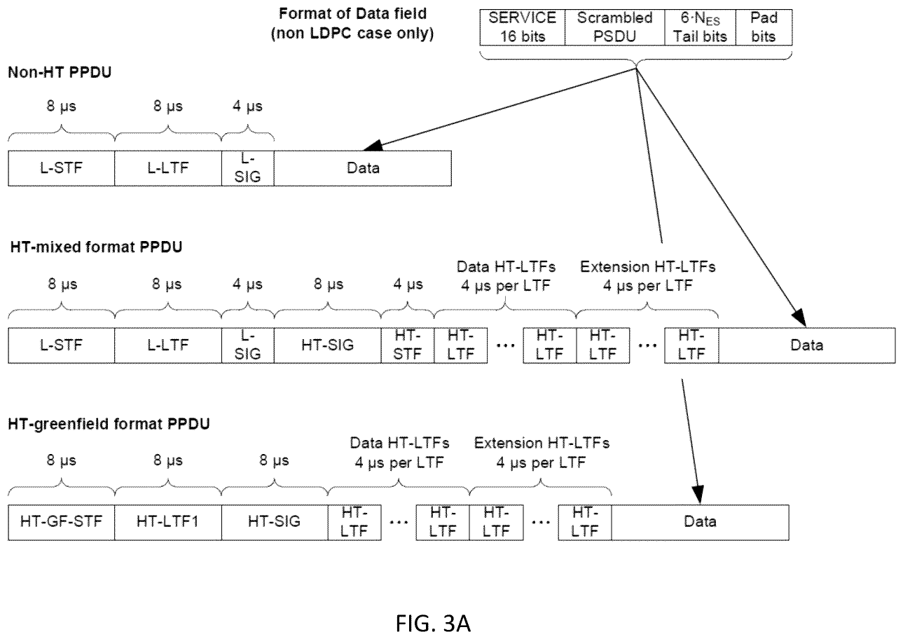

As another example, the hacker may transmit a signal that mimics the “echo” that would normally be received if a user were—but in fact is not—proximate to the computing system. This example is shown in FIG. 2, where a hacker's computer 235 sends a mimicked version of the “echo,” shown by arrow 245, which is meant to mimic the reflection of the transmitted signal (e.g., the transmission shown by arrow 220) that would normally be reflected by user 230 if user 230 were actually proximate to computer system 210.

As shown in FIG. 2, the user 230 is not actually proximate to the computing system 210, and in response to the wireless transmission shown by arrow 220, there is no echo received by computing system 210 (compare with FIG. 1, for example, where the echo shown by arrow 120 has been reflected off of proximate user 130). Although user 230 is not actually proximate to the computing system 210, the proximity detection system nevertheless receives the fraudulently-transmitted “echo” (arrow 245) sent by the hacker's computer 235, meaning that computing system 210 would not be able to detect that user 230 has stepped away from the computing system 210 and the computing system 210 would not take the associated action of locking the user interface, entering the low-power sleep mode, etc. in response to the proximity detection. This may allow the hacker to circumvent the automatic-locking proximity feature of the computing system 210 and/or disrupt other features that are based on proximity detection.

It may be easy for a hacker to mimic the echo of the wireless transmissions used for proximity detection when the proximity system uses standards-based wireless transmissions for proximity sensing measurements. For example, proximity sensing measurements may be based on a standards-based wireless local area network (WLAN) system such as the Institute of Electrical and Electronics Engineers (IEEE) 802.11 standards, also known as Wi-Fi®, which many computing systems support and utilize for wireless communications. See, e.g., IEEE Standard for Information Technology—Telecommunications and Information Exchange between Systems Local and Metropolitan Area Networks—Specific Requirements, Part 11: Wireless LAN Medium Access Control (MAC) and Physical Layer (PHY) Specifications (IEEE Std 802.11™-2020), Dec. 3, 2020, referred to herein as the “IEEE 802.11 standard.” Although the version published on Dec. 3, 2020 is used as an example, the proximity sensing disclosed below may be used with any version of the 802.11 standard, and the term “IEEE 802.11 standard” should be understood to encompass any version.

With respect to proximity sensing, a computing system may transmit and receive regular IEEE 802.11 frames/packets according to the standard in order to perform proximity sensing. The 802.11 frames/packets include, according to the IEEE 802.11 standard, a physical layer (PHY) preamble. As one particular example, an IEEE 802.11 orthogonal frequency division multiplexing (OFDM) preamble may contain Long Training Field (LTF) data that may be used by the wireless receiver to calculate channel information. Sampling of the received LTF data may then be used by proximity sensing of the computing system to determine whether an object (e.g., a user) is proximate to the computing system (e.g., proximate to the antennas of the wireless system). As should be understood, the IEEE 802.11 standard defines the LTF not as a single field, but rather as a set of LTF fields (e.g., L-LTF, HT-LTF, VHT-LTF, HE-LTF, etc.) used as long training sequences, which may depend on the type of frame and physical packet data unit (PPDU) transmitted.

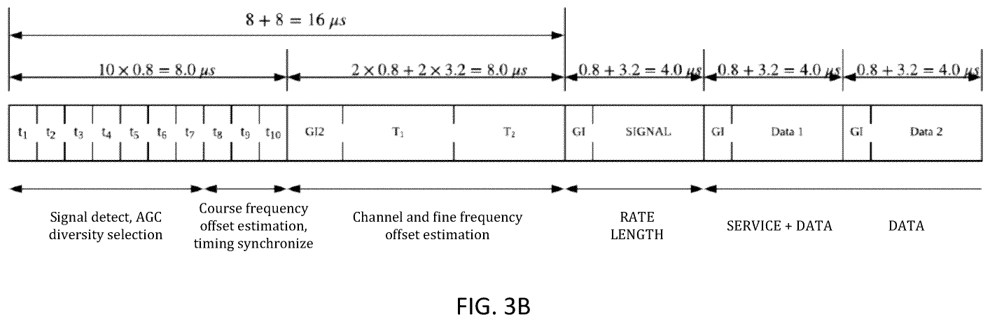

FIGS. 3A and 3B show how the IEEE 802.11 standard defines the header format of the various frames, which includes the associated training sequences that depend on the type of frame being transmitted. FIG. 3A shows that for a Non-HT PPDU, the first 20 μs are the training sequence, made up of a header containing short training field (L-STF), long training field (HT-LTF), and SIGNAL field (L-SIG). The HT-mixed format PPDU and HT-greenfield format PPDU have longer headers, defined by various different fields. FIG. 3B shows the detailed timing of the 20 μs training sequence (followed by 8 μs of data fields) of a non-HT PPDU and the various bits of information contained therein.

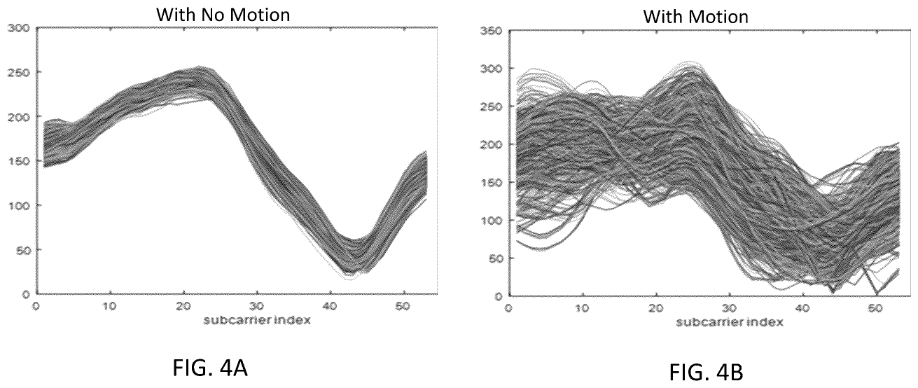

As one example of proximity sensing, a computing system may transmit a frame (e.g., an IEEE 802.11 PPDU) on a first antenna and monitor a second antenna for receipt of an “echo” of the transmitted frame. The computing system then processes the received LTF fields to calculate, per measurement, channel information (e.g., channel characteristics such as signal strengths at different subcarriers) over time. Then, the proximity sensing algorithm may compare the differences in the channel information measurements over a number (N) of measurements to determine proximity (e.g., whether the difference in measurements satisfy a predefined criterion indicating presence of an object/human user). FIGS. 4A and 4B show examples of measured signal amplitudes plotted across different subcarriers on a received frame. In a static environment (e.g., no motion), as shown in FIG. 4A, the measured amplitudes of the different subcarriers are relatively constant, whereas in a dynamic environment (e.g., where there is motion), as shown in FIG. 4B, the measured amplitudes of the different subcarriers have a large variation.

For a hacker to disrupt proximity sensing that transmits frames of PPDUs defined by the IEEE 802.11 standard, the hacker may either (1) spoof PPDUs or (2) spoof the LTF of the PPDUs. With packet spoofing, the hacker may sniff/record packets that contain proximity measurement data and then selectively re-transmit these packets to the computing system. With LTF spoofing, the hacker may use the LTF to generate frames with bogus channel measurements. In both cases, the channel measurement data used by the proximity sensing system may be impacted by the spoofed packet(s), causing the proximity sensing system to misreport the actual proximity of an object/human user to the computing system.

To provide robust protection against such spoofing, the disclosed proximity detection system, discussed in more detail below, may introduce a randomization into the transmitted frames. With a monostatic proximity detection system, the transmitter and receiver are controlled by and within the same computing system, so a predefined randomization may be applied to the transmission so that when it is received, the proximity detection system may check for the predefined randomization that was transmitted. This allows the proximity detection system to use a different randomization for each frame/packet so that it may then verify that the received frames/packets follow the applied randomization. Because the transmitter and receiver are within the same computing system, the transmitter may easily share the randomization/timing with the receiver on a frame-by-frame basis (e.g. a PPDU-by-PPDU basis), allowing the transmitter to use non-standards-based key generation schemes for LTF field data randomization.

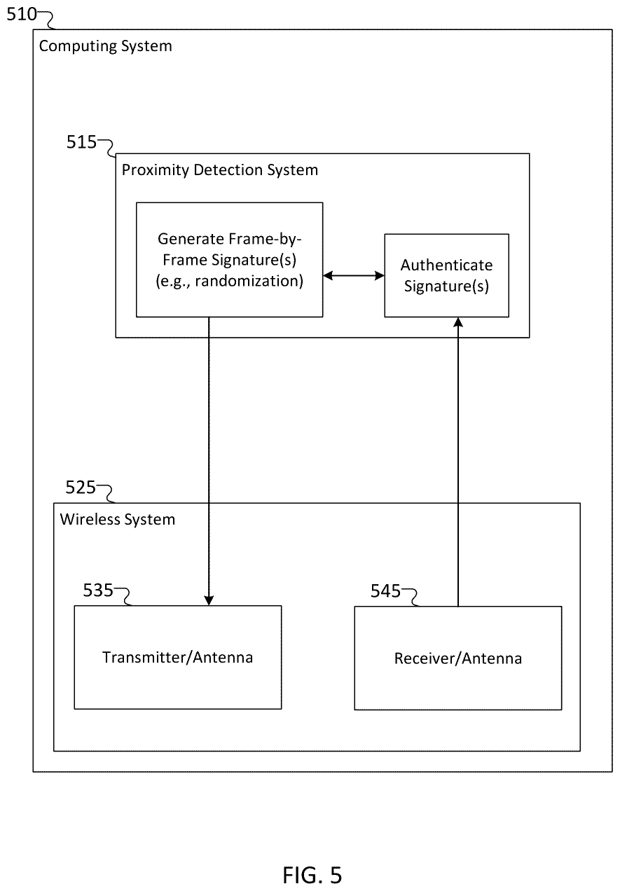

FIG. 5 shows a high level diagram of a computing system 510 with a proximity detection system 515 that may generate frame-by-frame signatures (e.g. a randomized header/preamble) for frames transmitted by the wireless system 525 (e.g. via the transmitter/antenna 535). The frames received by the wireless system 525 (e.g., via the receiver/antenna 545) may be authenticated by the proximity detection system 515 by checking whether the signature of the received frame matches the signature applied to the transmitted frame (e.g., the randomized header for the transmitted frame matches the randomized header of the received frame). Frames that do not have the matching signature may be ignored by the proximity detection system 515 so that their channel measurements do not negatively impact the proximity determination.

As should be understood, the IEEE 802.11 standard may be used as the wireless communication protocol for transmitting and receiving frames-except that the standard-defined training sequence may be replaced by a specialized frame-by-frame randomization provided by the proximity detection system 515. For example, the proximity detection system 515 may randomize and synchronize the transmitter 535's and receiver 545's per frame training sequences of the PHY preamble (e.g. L-LTF, HT-LTF, VHT-LTF, HE-LTF) to randomized preambles. Thus, when transmitting frames for proximity-relevant channel estimation, the received frames may be authenticated based on the randomized preamble (e.g., ignore received frames that do not have the specialized transmitted randomization). In addition, because the transmitter 535 and receiver 545 are within the same computing system (and often in the same wireless system 525, e.g. a wireless transceiver), the preamble need not be used for IEEE 802.11 synchronization, so the entire preamble may be used for the specialized randomization. In addition, the shorter frame types (e.g., non-HT legacy frames of earlier IEEE 802.11 standards, such as IEEE 802.11 a/g/n) may be used for transmitting/receiving channel measurements for proximity sensing, allowing for reduced over-the-air measurement time, reduced power consumption, and/or a lower overall operational impact to the wireless system.

In addition to a randomization of the PHY preamble, the proximity detection system 515 may send a specialized/randomized key as data (e.g., as part of the data field that follows the preamble/header fields) that changes on a frame-by-frame basis, rather than a simple non-packet-data (NPD) that is otherwise static across multiple frames. Each packet may be encrypted, scrambled, or have a one-time-per-frame padding. In addition, there may be specialized/randomized data in the MAC payload that changes from frame to frame and may also be used to authenticate the frame. In this sense, the specialized/randomized preamble and/or the specialized/randomized data may serve as a frame-by-frame “signature” that the proximity detection system 515 adds to each transmitted frame and that proximity detection system 515 uses to authenticate each received frame before using the channel measurement within the frame for proximity detection. This frame-by-frame signature may prevent a hacker from influencing proximity detection when the hacker transmits spoofed/recorded frames to the receiver, as such spoofed/recorded frames would not have the same signature as the transmitted frame and would therefore not be authenticated.

In addition, the proximity detection system 515 may evaluate the channel measurements in the authenticated frames and determine whether any single channel measurement contains an inconsistency as compared to other channel measurements to determine whether any channel measurement appears to be an outlier that should be excluded from the proximity determination. This may be referred to as outlier detection, and the proximity detection system 515 may use outlier detection to further protect against malicious attempts to fool the proximity detection system 515. The proximity detection system 515 may also utilize, in addition to the randomization(s) of the preamble and/or data, an encryption and/or scrambling algorithm to encrypt the randomization(s). This may add additional protection so that a hacker cannot simply guess the randomization. To encrypt and/or scramble the randomization(s), any type of encryption and/or scrambling algorithm may be used, including, for example, the advanced encryption standard (AES).

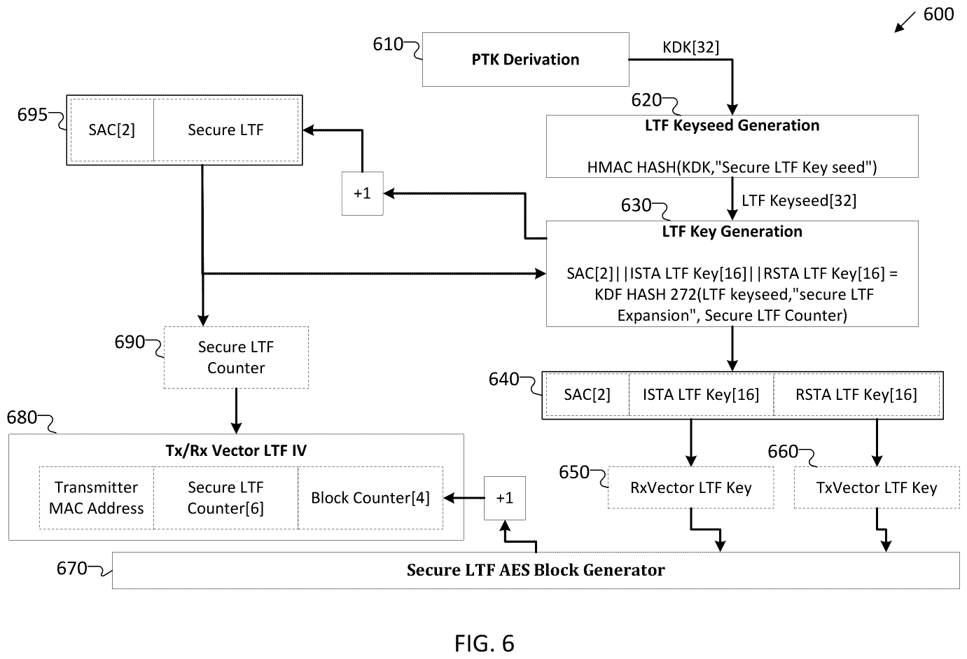

FIG. 6 shows an example of a proximity detection system 600 (e.g., proximity detection system 515) and, in particular, how randomizations may be used to generate a specialized, randomized preamble for signing transmitted frames and for authenticating received frames. In 610, pairwise transient key (PTK) derivation may provide a 32 bit key derivation key (KDK) for, in 620, LTF keyseed generation. The 32 bit, generated LTF keyseed may be provided for, at 630, LTF key generation. The generated LTF key, shown at 640, may include a 2 bit SAC, a 16 bit ISTA LTF key, and a 16 bit RSTA LTF key, which may be based on an incremented secure LTF shown at 695, and the counter for the secure LTF is shown at 690. The generated LTF key may represent an RX Vector LTF key, shown at 650, and a TX Vector LTF key, shown at 660, that are provided to the secure LTF AES Block Generator 670. This may be incremented to form the next TX/RX Vector LTF IV that includes a transmitter MAC address, a 6 bit secure LTF counter (from 690), and a 4 bit block counter. As should be understood, this randomization is merely exemplary and other randomizations and other bit lengths may be used to generate a specialized, randomized preamble for signing transmitted frames and for authenticating received frames.

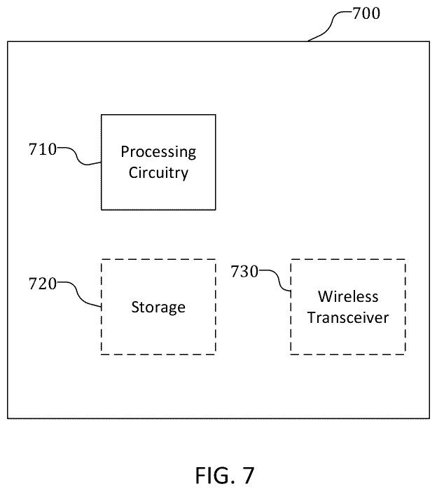

FIG. 7 is a schematic drawing illustrating a device 700 for wireless proximity detection of an object (e.g., a human user) with respect to a computing system. Device 700 may include any of the features of the wireless proximity detection system described. The wireless proximity detection system of FIG. 7 may be implemented as a device, a method, and/or a computer readable medium that, when executed, performs the features of the wireless proximity detection systems described above. It should be understood that device 700 is only an example, and other configurations may be possible that include, for example, different components or additional components.

Device 700 includes processing circuitry 710 connected to storage 720. In addition to or in combination with any of the features described in the following paragraphs, processing circuitry 710 is configured to transmit a series of transmitted wireless signal frames, each including a (e.g., predefined) signature that differs between consecutive frames of the series of transmitted wireless signal frames. In addition to or in combination with any of the features described in the following paragraphs, processing circuitry 710 is also configured to determine a validated frame subset from among a series of received wireless signal frames based on whether the series of received wireless signal frames includes the signature corresponding to the series of transmitted wireless signal frames. In addition to or in combination with any of the features described in the following paragraphs, processing circuitry 710 is also configured to determine a proximity of an object to a wireless antenna based on the validated frame subset.

Furthermore, in addition to or in combination with any of the features described in this or the preceding paragraph with respect to device 700, the series of received wireless signal frames may include a series of physical data packet units (PPDUs) with a header portion and data portion in a PPDU format defined by an Institute of Electrical and Electronics Engineers (IEEE) 802.11 standard, wherein the header portion may include the signature. Furthermore, in addition to or in combination with any of the features described in this or the preceding paragraph, the header portion may differ from a preamble defined by the IEEE 802.11 standard for a header of the PPDU format. Furthermore, in addition to or in combination with any of the features described in this or the preceding paragraph, the signature may be randomized for each frame in the series of transmitted wireless signal frames. Furthermore, in addition to or in combination with any of the features described in this or the preceding paragraph, the signature of one frame in the series of transmitted wireless signal frames may be different from the signature for each other frame in the series of transmitted wireless signal frames.

Furthermore, in addition to or in combination with any of the features described in this or the preceding two paragraphs, device 700 may further include a first antenna configured to receive the series of received wireless signal frames and a second antenna configured to transmit the series of transmitted wireless signal frames. Furthermore, in addition to or in combination with any of the features described in this or the preceding two paragraphs, the first antenna may be different from the second antenna. Furthermore, in addition to or in combination with any of the features described in this or the preceding two paragraphs, device 700 may further include a wireless transceiver 730 including the first antenna and the second antenna. Furthermore, in addition to or in combination with any of the features described in this or the preceding two paragraphs, processing circuitry 710 may be configured to generate the signature based on a randomly-generated preamble padding that is different for each transmitted wireless signal frame of the series of transmitted wireless signal frames.

Furthermore, in addition to or in combination with any of the features described in this or the preceding three paragraphs with respect to device 700, processing circuitry 710 may be configured to generate the signature based on a randomly-generated physical layer (PHY) data packet header that is different for each frame of the series of transmitted wireless signal frames. Furthermore, in addition to or in combination with any of the features described in this or the preceding three paragraphs, the signature may be contained within a physical layer (PHY) header, a medium access layer (MAC) header, or a data payload of one or more of the series of transmitted wireless signal frames, wherein the signature differs between consecutive frames of the series of transmitted wireless signal frames, wherein processing circuitry 710 may be configured to generate the signature based on a randomly-generated frame identifier that is different for each frame of the series of transmitted wireless signal frames.

Furthermore, in addition to or in combination with any of the features described in this or the preceding four paragraphs with respect to device 700, wherein the signature may be contained within MAC data packets of the transmitted wireless signal frames, wherein the signature differs between consecutive MAC data packets, wherein processing circuitry 710 may be configured to generate the signature based on a randomly-generated MAC identifier that is different for each frame of the series of transmitted wireless signal frames. Furthermore, in addition to or in combination with any of the features described in this or the preceding four paragraphs, processing circuitry 710 may be further configured to generate a control signal configured to lock or unlock access to a computing device based on the proximity. Furthermore, in addition to or in combination with any of the features described in this or the preceding four paragraphs, processing circuitry 710 may be further configured to generate a control signal configured to adjust a power setting of a computing device based on the proximity.

Furthermore, in addition to or in combination with any of the features described in this or the preceding five paragraphs with respect to device 700, wherein the processing circuitry 710 configured to determine the proximity of the object may include processing circuitry 710 configured to analyze differences in channel information measurements contained within the series of received wireless signal frames and determine the proximity based on the differences in the channel information measurements. Furthermore, in addition to or in combination with any of the features described in this or the preceding five paragraphs, the channel information measurements may include signal amplitudes on subcarriers of wireless channels. Furthermore, in addition to or in combination with any of the features described in this or the preceding five paragraphs, the computing device may include a laptop computer, a desktop computer, a smartphone, a computing terminal, or a wearable.

Furthermore, in addition to or in combination with any of the features described in this or the preceding six paragraphs with respect to device 700, each frame of the series of transmitted wireless frames may include a header and a payload, wherein the signature may include at least a portion of the header. Furthermore, in addition to or in combination with any of the features described in this or the preceding six paragraphs, processing circuitry 710 may be further configured to encrypt the signature by an encryption key. Furthermore, in addition to or in combination with any of the features described in this or the preceding six paragraphs, processing circuitry 710 may be further configured to randomly generate the encryption key.

Furthermore, in addition to or in combination with any of the features described in this or the preceding seven paragraphs with respect to device 700, the series of received wireless signal frames may include physical layer packet frames each with a frame format that is defined by an IEEE 802.11 standard. Furthermore, in addition to or in combination with any of the features described in this or the preceding seven paragraphs, at least one frame of the physical layer packet frames may include a physical layer preamble that is different from a preamble for the frame format defined by the IEEE 802.11 standard. Furthermore, in addition to or in combination with any of the features described in this or the preceding seven paragraphs, the physical layer preamble may include at least a portion of the signature. Furthermore, in addition to or in combination with any of the features described in this or the preceding seven paragraphs, the physical layer preamble may include a training structure. Furthermore, in addition to or in combination with any of the features described in this or the preceding seven paragraphs, the training structure may include a short training field (L-STF), a long training field (S-STF), and/or a signal field (L-SIG). Furthermore, in addition to or in combination with any of the features described in this or the preceding seven paragraphs, processing circuitry 710 may be configured to determine the validated frame subset further based on an inconsistency among channel information measurements contained within the transmitted wireless signal frames.

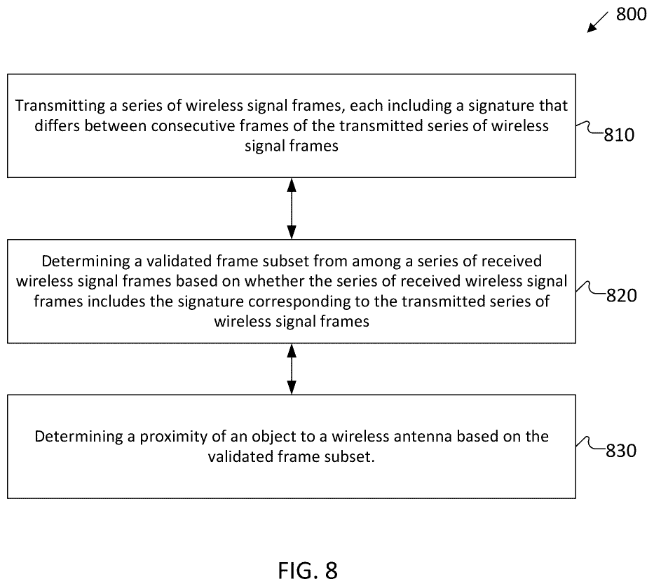

FIG. 8 depicts a schematic flow diagram of a method 800 for wireless proximity detection of an object (e.g., a human user) with respect to a computing system. Method 800 may implement any of the features of the wireless proximity detection systems described above.

Method 800 includes, in 810, transmitting a series of wireless signal frames, each including a (e.g., predefined) signature that differs between consecutive frames of the transmitted series of wireless signal frames. Method 800 also includes, in 820, determining a validated frame subset from among a series of received wireless signal frames based on whether the series of received wireless signal frames includes the signature corresponding to the transmitted series of wireless signal frames. Method 800 also includes, in 830, determining a proximity of an object to a wireless antenna based on the validated frame subset.

In the following, various examples are provided that may include one or more features of the wireless proximity detection systems discussed above. It may be intended that aspects described in relation to the devices may apply also to the described method(s), and vice versa.

Example 1 is a device including processing circuitry coupled to storage. The processing circuitry is configured to transmit a series of transmitted wireless signal frames, each including a (e.g., predefined) signature that differs between consecutive frames of the series of transmitted wireless signal frames. The processing circuitry is also configured to determine a validated frame subset from among a series of received wireless signal frames based on whether the series of received wireless signal frames includes the signature corresponding to the series of transmitted wireless signal frames. The processing circuitry is also configured to determine a proximity of an object to a wireless antenna based on the validated frame subset.

Example 2 is the device of example 1, wherein the series of received wireless signal frames include a series of physical data packet units (PPDUs) with a header portion and data portion in a PPDU format defined by an Institute of Electrical and Electronics Engineers (IEEE) 802.11 standard, wherein the header portion includes the signature.

Example 3 is the device of example 2, wherein the header portion differs from a preamble defined by the IEEE 802.11 standard for a header of the PPDU format.

Example 4 is the device of example 1, wherein the signature is randomized for each frame in the series of transmitted wireless signal frames.

Example 5 is the device of any of examples 1 to 4, wherein the signature of one frame in the series of transmitted wireless signal frames is different from the signature for each other frame in the series of transmitted wireless signal frames.

Example 6 is the device of any of examples 1 to 5, the device further including a first antenna configured to receive the series of received wireless signal frames and a second antenna configured to transmit the series of transmitted wireless signal frames.

Example 7 is the device of example 6, wherein the first antenna is different from the second antenna.

Example 8 is the device of either one of examples 6 or 7, the device further including a wireless system including the first antenna and the second antenna.

Example 9 is the device of any of examples 1 to 8, wherein the processing circuitry is configured to generate the signature based on a randomly-generated preamble padding that is different for each transmitted wireless signal frame of the series of transmitted wireless signal frames.

Example 10 is the device of any of examples 1 to 9, wherein the processing circuitry is configured to generate the signature based on a randomly-generated physical layer (PHY) data packet header that is different for each frame of the series of transmitted wireless signal frames.

Example 11 is the device of any of examples 1 to 10, wherein the signature is contained within a physical layer (PHY) header, a medium access layer (MAC) header, or a data payload of one or more of the series of transmitted wireless signal frames, wherein the signature differs between consecutive frames of the series of transmitted wireless signal frames, wherein the processing circuitry is configured to generate the signature based on a randomly-generated frame identifier that is different for each frame of the series of transmitted wireless signal frames.

Example 12 is the device of any of examples 1 to 11, wherein the processing circuitry is configured to generate the signature based on a randomly-generated medium access (MAC) header that is different for each frame of the series of transmitted wireless signal frames.

Example 13 is the device of any of examples 1 to 12, wherein the signature is contained within MAC data packets of the transmitted wireless signal frames, wherein the signature differs between consecutive MAC data packets, wherein the processing circuitry is configured to generate the signature based on a randomly-generated MAC identifier that is different for each MAC data packet.

Example 14 is the device of any of examples 1 to 13, wherein the processing circuitry is further configured to generate a control signal configured to lock or unlock access to a computing device based on the proximity.

Example 15 is the device of any of examples 1 to 14, wherein the processing circuitry is further configured to generate a control signal configured to adjust a power setting of a computing device based on the proximity.

Example 16 is the device of any of examples 1 to 15, wherein the processing circuitry configured to determine the proximity of the object includes the processing circuitry configured to analyze differences in channel information measurements contained within the series of received wireless signal frames and determine the proximity based on the differences in the channel information measurements.

Example 17 is the device of example 16, wherein the channel information measurements include signal amplitudes on subcarriers of wireless channels.

Example 18 is the device of any of examples 14 to 17, wherein the computing device includes a laptop computer, a desktop computer, a smartphone, a computing terminal, or a wearable.

Example 19 is the device of any of examples 1 to 18, wherein each frame of the series of transmitted wireless signal frames includes a header and a payload, wherein the signature includes at least a portion of the header.

Example 20 is the device of any of examples 1 to 19, wherein the processing circuitry is further configured to encrypt the signature by an encryption key.

Example 21 is the device of example 20, wherein the processing circuitry is further configured to randomly generate the encryption key.

Example 22 is the device of any of examples 1 to 21, wherein the series of received wireless signal frames include physical layer packet frames with a frame format that is defined by an IEEE 802.11 standard.

Example 23 is the device of example 22, wherein at least one frame of the physical layer packet frames includes a physical layer preamble that is different from a preamble for the frame format defined by the IEEE 802.11 standard.

Example 24 is the device of example 23, wherein the physical layer preamble includes at least a portion of the signature.

Example 25 is the device of either one of examples 23 to 24, wherein the physical layer preamble includes a training structure.

Example 26 is the device of example 25, wherein the training structure includes a short training field (L-STF), a long training field (S-STF), and/or a signal field (L-SIG).

Example 27 is the device of any of examples 1 to 26, wherein the processing circuitry is configured to determine the validated frame subset further based on an inconsistency among channel information measurements contained within the transmitted wireless signal frames.

Example 28 is method that includes transmitting a series of wireless signal frames, each including a (e.g., predefined) signature that differs between consecutive frames of the transmitted series of wireless signal frames. The method also includes determining a validated frame subset from among a series of received wireless signal frames based on whether the series of received wireless signal frames includes the signature corresponding to the transmitted series of wireless signal frames. The method also includes determining a proximity of an object to a wireless antenna based on the validated frame subset.

Example 29 is the method of example 28, wherein the series of received wireless signal frames include a series of physical data packet units (PPDUs) with a header portion and data portion in a PPDU format defined by an Institute of Electrical and Electronics Engineers (IEEE) 802.11 standard, wherein the header portion includes the signature.

Example 30 is the method of example 29, wherein the header portion differs from a preamble defined by the IEEE 802.11 standard for a header of the PPDU format.

Example 31 is the method of example 28, wherein the signature is randomized for each frame in the transmitted series of wireless signal frames.

Example 32 is the method of any of examples 28 to 31, wherein the signature of one frame in the transmitted series of wireless signal frames is different from the signature for each other frame in the transmitted series of wireless signal frames.

Example 33 is the method of any of examples 28 to 32, the method further including receiving the series of received wireless signal frames via a first antenna and transmitting the transmitted series of wireless signal frames via a second antenna.

Example 34 is the method of example 33, wherein the first antenna is different from the second antenna.

Example 35 is the method of either one of examples 33 or 34, wherein a wireless system includes the first antenna and the second antenna.

Example 36 is the method of any of examples 28 to 35, further including generating the signature based on a randomly-generated preamble padding that is different for each transmitted wireless signal frame of the transmitted series of wireless signal frames.

Example 37 is the method of any of examples 28 to 36, the method further including generating the signature based on a randomly-generated physical layer (PHY) data packet header that is different for each frame of the transmitted series of wireless signal frames.

Example 38 is the method of any of examples 28 to 37, wherein the signature is contained within a physical layer (PHY) header, a medium access layer (MAC) header, or a data payload of one or more of the series of transmitted wireless signal frames, wherein the signature differs between consecutive frames of the series of transmitted wireless signal frames, wherein the method further includes generating the signature based on a randomly-generated frame identifier that is different for each frame of the series of transmitted wireless signal frames.

Example 39 is the method of any of examples 28 to 38, the method further including generating the signature based on a randomly-generated medium access (MAC) header that is different for frame of the transmitted series of wireless signal frames.

Example 40 is the method of any of examples 28 to 39, wherein the signature is contained within MAC data packets of the transmitted wireless signal frames, wherein the signature differs between consecutive MAC data packets, wherein the method further includes generating the signature based on a randomly-generated MAC identifier that is different for each MAC data packet.

Example 41 is the method of any of examples 28 to 40, the method further including generating a control signal configured to lock or unlock access to a computing device based on the proximity.

Example 42 is the method of any of examples 28 to 41, the method further including generating a control signal configured to adjust a power setting of a computing device based on the proximity.

Example 43 is the method of any of examples 28 to 42, wherein the determining the proximity of the object includes analyzing differences in channel information measurements contained within the series of received wireless signal frames and determining the proximity based on the differences in the channel information measurements.

Example 44 is the method of example 43, wherein the channel information measurements include signal amplitudes on subcarriers of wireless channels.

Example 45 is the method of any of examples 41 to 44, wherein the computing device includes a laptop computer, a desktop computer, a smartphone, a computing terminal, or a wearable.

Example 46 is the method of any of examples 28 to 45, wherein each frame of the series of received wireless signal frames includes a header and a payload, wherein the signature includes at least a portion of the header.

Example 47 is the method of any of examples 28 to 46, the method further including encrypting the signature by an encryption key.

Example 48 is the method of example 47, the method further including randomly generating the encryption key.

Example 49 is the method of any of examples 28 to 48, wherein the series of received wireless signal frames include physical layer packet frames with a frame format that is defined by an IEEE 802.11 standard.

Example 50 is the method of example 49, wherein at least one frame of the physical layer packet frames includes a physical layer preamble that is different from a preamble for the frame format defined by the IEEE 802.11 standard.

Example 51 is the method of example 50, wherein the physical layer preamble includes at least a portion of the signature.

Example 52 is the method of either one of examples 50 to 51, wherein the physical layer preamble includes a training structure.

Example 53 is the method of example 52, wherein the training structure includes a short training field (L-STF), a long training field (S-STF), and/or a signal field (L-SIG).

Example 54 is the method of any of examples 28 to 53, the method further including determining the validated frame subset further based on an inconsistency among channel information measurements contained within the transmitted wireless signal frames.

Example 55 is an apparatus that includes a means for transmitting a series of wireless signal frames, each including a (e.g., predefined) signature that differs between consecutive frames of the transmitted series of wireless signal frames. The apparatus also includes a means for determining a validated frame subset from among a series of received wireless signal frames based on whether the series of received wireless signal frames includes the signature corresponding to the transmitted series of wireless signal frames. The apparatus also includes a means for determining a proximity of an object to a wireless antenna based on the validated frame subset.

Example 56 is the apparatus of example 55, wherein the series of received wireless signal frames include a series of physical data packet units (PPDUs) with a header portion and data portion in a PPDU format defined by an Institute of Electrical and Electronics Engineers (IEEE) 802.11 standard, wherein the header portion includes the signature.

Example 57 is the apparatus of example 56, wherein the header portion differs from a preamble defined by the IEEE 802.11 standard for a header of the PPDU format.

Example 58 is the apparatus of example 55, wherein the signature is randomized for each frame in the transmitted series of wireless signal frames.

Example 59 is the apparatus of any of examples 55 to 58, wherein the signature of one frame in the transmitted series of wireless signal frames is different from the signature for each other frame in the transmitted series of wireless signal frames.

Example 60 is the apparatus of any of examples 55 to 59, the apparatus further including a means for receiving the series of received wireless signal frames via a first antenna and a means for transmitting the transmitted series of wireless signal frames via a second antenna.

Example 61 is the apparatus of example 60, wherein the first antenna is different from the second antenna.

Example 62 is the apparatus of either one of examples 60 or 61, wherein a wireless system includes the first antenna and the second antenna.

Example 63 is the apparatus of any of examples 55 to 62, further including a means for generating the signature based on a randomly-generated preamble padding that is different for each transmitted wireless signal frame of the transmitted series of wireless signal frames.

Example 64 is the apparatus of any of examples 55 to 63, the apparatus further including a means for generating the signature based on a randomly-generated physical layer (PHY) data packet header that is different for each frame of the series of transmitted wireless signal frames.

Example 65 is the apparatus of any of examples 55 to 64, wherein the signature is contained within a physical layer (PHY) header, a medium access layer (MAC) header, or a data payload of one or more of the series of transmitted wireless signal frames, wherein the signature differs between consecutive frames of the series of transmitted wireless signal frames, wherein the apparatus further includes a means for generating the signature based on a randomly-generated frame identifier that is different for each frame of the series of transmitted wireless signal frames.

Example 66 is the apparatus of any of examples 55 to 65, the apparatus further including a means for generating the signature based on a randomly-generated medium access (MAC) header that is different for each frame of the transmitted series of wireless signal frames.

Example 67 is the apparatus of any of examples 55 to 66, wherein the signature is contained within MAC data packets of the transmitted wireless signal frames, wherein the signature differs between consecutive MAC data packets, wherein the apparatus further includes a means for generating the signature based on a randomly-generated MAC identifier that is different for each MAC data packet.

Example 68 is the apparatus of any of examples 55 to 67, the apparatus further including a means for generating a control signal configured to lock or unlock access to a computing device based on the proximity.

Example 69 is the apparatus of any of examples 55 to 68, the apparatus further including a means for generating a control signal configured to adjust a power setting of a computing device based on the proximity.

Example 70 is the apparatus of any of examples 55 to 69, wherein the means for determining the proximity of the object includes a means for analyzing differences in channel information measurements contained within the series of received wireless signal frames and a means for determining the proximity based on the differences in the channel information measurements.

Example 71 is the apparatus of example 70, wherein the channel information measurements include signal amplitudes on subcarriers of wireless channels.

Example 72 is the apparatus of any of examples 68 to 71, wherein the computing device includes a laptop computer, a desktop computer, a smartphone, a computing terminal, or a wearable.

Example 73 is the apparatus of any of examples 55 to 72, wherein each frame of the series of received wireless signal frames includes a header and a payload, wherein the signature includes at least a portion of the header.

Example 74 is the apparatus of any of examples 55 to 73, the apparatus further including a means for encrypting the signature by an encryption key.

Example 75 is the apparatus of example 74, the apparatus further including a means for randomly generating the encryption key.

Example 76 is the apparatus of any of examples 55 to 75, wherein the series of received wireless signal frames include physical layer packet frames with a frame format that is defined by an IEEE 802.11 standard.

Example 77 is the apparatus of example 76, wherein at least one frame of the physical layer packet frames includes a physical layer preamble that is different from a preamble for the frame format defined by the IEEE 802.11 standard.

Example 78 is the apparatus of example 77, wherein the physical layer preamble includes at least a portion of the signature.

Example 79 is the apparatus of either one of examples 77 to 78, wherein the physical layer preamble includes a training structure.

Example 80 is the apparatus of example 79, wherein the training structure includes a short training field (L-STF), a long training field (S-STF), and/or a signal field (L-SIG).

Example 81 is the apparatus of any of examples 55 to 80, the apparatus further including a means for determining the validated frame subset further based on an inconsistency among channel information measurements contained within the transmitted wireless signal frames.

Example 82 is a non-transitory, computer-readable medium including instructions that, when executed, cause one or more processors to transmit a series of transmitted wireless signal frames, each including a (e.g., predefined) signature that differs between consecutive frames of the series of transmitted wireless signal frames. The instructions also cause the one or more processors to determine a validated frame subset from among a series of received wireless signal frames based on whether the series of received wireless signal frames includes the signature corresponding to the series of transmitted wireless signal frames. The instructions also cause the one or more processors to determine a proximity of an object to a wireless antenna based on the validated frame subset.

Example 83 is the non-transitory, computer-readable medium of example 82, wherein the series of received wireless signal frames include a series of physical data packet units (PPDUs) with a header portion and data portion in a PPDU format defined by an Institute of Electrical and Electronics Engineers (IEEE) 802.11 standard, wherein the header portion includes the signature.

Example 84 is the non-transitory, computer-readable medium of example 83, wherein the header portion differs from a preamble defined by the IEEE 802.11 standard for a header of the PPDU format.

Example 85 is the non-transitory, computer-readable medium of example 82, wherein the signature is randomized for each frame in the series of transmitted wireless signal frames.

Example 86 is the non-transitory, computer-readable medium of any of examples 82 to 85, wherein the signature of one frame in the series of transmitted wireless signal frames is different from the signature for each other frame in the series of transmitted wireless signal frames.

Example 87 is the non-transitory, computer-readable medium of any of examples 82 to 86, wherein the instructions also cause the one or more processors to receive via a first antenna the series of received wireless signal frames, wherein the instructions also cause the one or more processors to transmit via a second antenna the series of transmitted wireless signal frames.

Example 88 is the non-transitory, computer-readable medium of example 87, wherein the first antenna is different from the second antenna.

Example 89 is the non-transitory, computer-readable medium of either one of examples 87 or 88, wherein the first antenna and the second antenna are included in a wireless system.

Example 90 is the non-transitory, computer-readable medium of any of examples 82 to 89, wherein instructions also cause the one or more processors to generate the signature based on a randomly-generated preamble padding that is different for each transmitted wireless signal frame of the series of transmitted wireless signal frames.

Example 91 is the non-transitory, computer-readable medium of any of examples 82 to 90, wherein the instructions also cause the one or more processors to generate the signature based on a randomly-generated physical layer (PHY) data packet header that is different for each frame of the series of transmitted wireless signal frames.

Example 92 is the non-transitory, computer-readable medium of any of examples 82 to 91, wherein the signature is contained within a physical layer (PHY) header, a medium access layer (MAC) header, or a data payload of one or more of the series of transmitted wireless signal frames, wherein the signature differs between consecutive frames of the series of transmitted wireless signal frames, wherein the instructions also cause the one or more processors to generate the signature based on a randomly-generated frame identifier that is different for each frame of the series of transmitted wireless signal frames.

Example 93 is the non-transitory, computer-readable medium of any of examples 82 to 92, wherein the instructions also cause the one or more processors to generate the signature based on a randomly-generated medium access (MAC) header that is different for each frame of the series of transmitted wireless signal frames.

Example 94 is the non-transitory, computer-readable medium of any of examples 82 to 93, wherein the signature is contained within MAC data packets of the transmitted wireless signal frames, wherein the signature differs between consecutive MAC data packets, wherein the instructions also cause the one or more processors to generate the signature based on a randomly-generated MAC identifier that is different for each MAC data packet.

Example 95 is the non-transitory, computer-readable medium of any of examples 82 to 94, wherein the instructions also cause the one or more processors to generate a control signal configured to lock or unlock access to a computing device based on the proximity.

Example 96 is the non-transitory, computer-readable medium of any of examples 82 to 95, wherein the instructions also cause the one or more processors to generate a control signal configured to adjust a power setting of a computing device based on the proximity.

Example 97 is the non-transitory, computer-readable medium of any of examples 82 to 96, wherein the instructions that cause the one or more processors to determine the proximity of the object includes that the instructions also cause the one or more processors to analyze differences in channel information measurements contained within the series of received wireless signal frames, wherein the instructions also cause the one or more processors to determine the proximity based on the differences in the channel information measurements.

Example 98 is the non-transitory, computer-readable medium of example 97, wherein the channel information measurements include signal amplitudes on subcarriers of wireless channels.

Example 99 is the non-transitory, computer-readable medium of any of examples 95 to 98, wherein the computing device includes a laptop computer, a desktop computer, a smartphone, a computing terminal, or a wearable.

Example 100 is the non-transitory, computer-readable medium of any of examples 82 to 99, wherein each frame in series of received wireless signal frames includes a header and a payload, wherein the signature includes at least a portion of the header.

Example 101 is the non-transitory, computer-readable medium of any of examples 82 to 100, wherein the instructions also cause the one or more processors to encrypt the signature by an encryption key.

Example 102 is the non-transitory, computer-readable medium of example 101, wherein the instructions also cause the one or more processors to randomly generate the encryption key.

Example 103 is the non-transitory, computer-readable medium of any of examples 82 to 102, wherein the series of received wireless signal frames include physical layer packet frames with a frame format that is defined by an IEEE 802.11 standard.

Example 104 is the non-transitory, computer-readable medium of example 103, wherein at least one frame of the physical layer packet frames includes a physical layer preamble that is different from a preamble for the frame format defined by the IEEE 802.11 standard.

Example 105 is the non-transitory, computer-readable medium of example 104, wherein the physical layer preamble includes at least a portion of the signature.

Example 106 is the non-transitory, computer-readable medium of either one of examples 104 to 105, wherein the physical layer preamble includes a training structure.

Example 107 is the non-transitory, computer-readable medium of example 106, wherein the training structure includes a short training field (L-STF), a long training field (S-STF), and/or a signal field (L-SIG).

Example 108 is the non-transitory, computer-readable medium of any of examples 82 to 107, wherein the instructions also cause the one or more processors to determine the validated frame subset further based on an inconsistency among channel information measurements contained within the transmitted wireless signal frames.

Example 109 is a system including a wireless transceiver configured to transmit multiple wireless data transmission frames and to receive multiple wireless data reception frames. The device also includes a user interface for interacting with a user of the device. The device also includes a processor configured to change access to the user interface based on a proximity of the user to the wireless transceiver, wherein the processor is configured to determine the proximity based on channel measurement information in a validated subset of data frames and to select the validated subset of data frames from among the multiple wireless data reception frames based on whether the multiple wireless data reception frames include a (e.g., predefined) signature within the multiple wireless data transmission frames.

Example 110 is the system of example 109, wherein the multiple wireless data reception frames include a series of physical data packet units (PPDUs) with a header portion and data portion in a PPDU format defined by an Institute of Electrical and Electronics Engineers (IEEE) 802.11 standard, wherein the header portion includes the signature.

Example 111 is the system of example 110, wherein the header portion differs from a preamble defined by the IEEE 802.11 standard for a header of the PPDU format.

Example 112 is the system of example 109, wherein the signature is randomized for each frame in the multiple wireless data transmission frames.

Example 113 is the system of any of examples 109 to 112, wherein the signature of one frame in the multiple wireless data transmission frames is different from the signature for each other frame in the multiple wireless data transmission frames.

Example 114 is the system of any of examples 109 to 113, the wireless transceiver further including a first antenna configured to receive the multiple wireless data reception frames and a second antenna configured to transmit the multiple wireless data transmission frames.

Example 115 is the system of example 114, wherein the first antenna is different from the second antenna.

Example 116 is the system of any of examples 109 to 115, wherein the processor is configured to generate the signature based on a randomly-generated preamble padding that is different for each transmitted frame of the multiple wireless data transmission frames.

Example 117 is the system of any of examples 109 to 116, wherein the processor is configured to generate the signature based on a randomly-generated physical layer (PHY) data packet header that is different for each frame of the series of transmitted wireless signal frames.

Example 118 is the system of any of examples 109 to 117, wherein the signature is contained within a physical layer (PHY) header, a medium access layer (MAC) header, or a data payload of one or more of the series of transmitted wireless signal frames, wherein the signature differs between consecutive frames of the series of transmitted wireless signal frames, wherein the processor is configured to generate the signature based on a randomly-generated frame identifier that is different for each frame of the series of transmitted wireless signal frames.

Example 119 is the system of any of examples 109 to 118, wherein the processor is configured to generate the signature based on a randomly-generated medium access (MAC) header that is different for each frame of the series of transmitted wireless signal frames.

Example 120 is the system of any of examples 109 to 119, wherein the signature is contained within MAC data packets of the multiple wireless data transmission frames, wherein the signature differs between consecutive MAC data packets, wherein the processor is configured to generate the signature based on a randomly-generated MAC identifier that is different for each MAC data packet.

Example 121 is the system of any of examples 109 to 120, wherein the processor is further configured to generate a control signal configured to adjust a power setting of the processor based on the proximity.

Example 122 is the system of any of examples 109 to 121, wherein the processor configured to determine the proximity includes the processor configured to analyze differences in channel information measurements contained within the multiple wireless data reception frames and determine the proximity based on the differences in the channel information measurements.

Example 123 is the system of example 122, wherein the channel information measurements include signal amplitudes on subcarriers of wireless channels.

Example 124 is the system of any of examples 109 to 123, wherein the system is included in a computing device that includes a laptop computer, a desktop computer, a smartphone, a computing terminal, or a wearable.

Example 125 is the system of any of examples 109 to 124, wherein the multiple wireless data reception frames each includes a header and a payload, wherein the signature includes at least a portion of the header.

Example 126 is the system of any of examples 109 to 125, wherein the processor is further configured to encrypt the signature by an encryption key.

Example 127 is the system of example 126, wherein the processor is further configured to randomly generate the encryption key.

Example 128 is the system of any of examples 109 to 127, wherein the multiple wireless data reception frames include physical layer packet frames with a frame format that is defined by an IEEE 802.11 standard.

Example 129 is the system of example 128, wherein at least one frame of the physical layer packet frames includes a physical layer preamble that is different from a preamble for the frame format defined by the IEEE 802.11 standard.

Example 130 is the system of example 129, wherein the physical layer preamble includes at least a portion of the signature.

Example 131 is the system of either one of examples 129 to 130, wherein the physical layer preamble includes a training structure.

Example 132 is the system of example 131, wherein the training structure includes a short training field (L-STF), a long training field (S-STF), and/or a signal field (L-SIG).

Example 133 is the system of any of examples 109 to 132, wherein the processor is configured to determine the validated subset of data frames further based on an inconsistency among channel information measurements contained within the multiple wireless data transmission frames.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising processing circuitry coupled to storage, the processing circuitry configured to:
transmit a series of transmitted wireless signal frames, each comprising a signature that differs between consecutive frames of the series of transmitted wireless signal frames;
determine a validated frame subset from among a series of received wireless signal frames based on whether the series of received wireless signal frames includes the signature corresponding to the series of transmitted wireless signal frames; and
determine a proximity of an object to a wireless antenna based on the validated frame subset.

2. The device of claim 1, wherein the series of received wireless signal frames comprise a series of physical data packet units (PPDUs) with a header portion and data portion in a PPDU format defined by an IEEE 802.11 standard, wherein the header portion comprises the signature.

3. The device of claim 2, wherein the header portion differs from a preamble defined by the IEEE 802.11 standard for a header of the PPDU format.

4. The device of claim 1, wherein the signature is randomized for each frame in the series of transmitted wireless signal frames.

5. The device of claim 1, wherein the signature of one frame in the series of transmitted wireless signal frames is different from the signature for each other frame in the series of transmitted wireless signal frames.

6. The device of claim 1, the device further comprising a first antenna configured to receive the series of received wireless signal frames and a second antenna configured to transmit the series of transmitted wireless signal frames, wherein the first antenna is different from the second antenna.

7. The device of claim 1, wherein the processing circuitry is configured to generate the signature based on a randomly-generated preamble padding that is different for each transmitted wireless signal frame of the series of transmitted wireless signal frames.

8. The device of claim 1, wherein the processing circuitry is configured to generate the signature based on a randomly-generated physical layer data packet header that is different for each frame of the series of transmitted wireless signal frames.

9. The device of claim 1, wherein the signature is contained within a physical layer (PHY) header, a medium access layer (MAC) header, or a data payload of one or more of the series of transmitted wireless signal frames, wherein the signature differs between consecutive transmitted frames of the series of transmitted wireless signal frames, wherein the processing circuitry is configured to generate the signature based on a randomly-generated frame identifier that is different for each frame of the series of transmitted wireless signal frames.

10. The device of claim 1, wherein the processing circuitry is further configured to generate a control signal configured to lock or unlock access to a computing device based on the proximity and/or to adjust a power setting of a computing device based on the proximity.

11. A non-transitory, computer-readable medium comprising instructions that, when executed, cause one or more processors to:
transmit a series of transmitted wireless signal frames, each comprising a signature that differs between consecutive frames of the series of transmitted wireless signal frames;
determine a validated frame subset from among a series of received wireless signal frames based on whether the series of received wireless signal frames includes the signature corresponding to the series of transmitted wireless signal frames; and
determine a proximity of an object to a wireless antenna based on the validated frame subset.

12. The non-transitory, computer-readable medium of claim 11, wherein the instructions that cause the one or more processors to determine the proximity of the object comprises that the instructions cause the one or more processors to analyze differences in channel information measurements contained within the series of received wireless signal frames and to determine the proximity based on the differences in the channel information measurements.

13. The non-transitory, computer-readable medium of claim 12, wherein the channel information measurements comprise signal amplitudes on subcarriers of wireless channels.

14. The non-transitory, computer-readable medium of claim 11, wherein each frame of the series of received wireless signal frames comprises a header and a payload, wherein the signature comprises at least a portion of the header.

15. The non-transitory, computer-readable medium of claim 11, wherein the instructions further cause the one or more processors to encrypt the signature by an encryption key that is randomly generated.

16. The non-transitory, computer-readable medium of claim 11, wherein the series of received wireless signal frames comprise physical layer packet frames with a frame format that is defined by an IEEE 802.11 standard, wherein at least one frame of the physical layer packet frames comprises a physical layer preamble that is different from a preamble for the frame format defined by the IEEE 802.11 standard.

17. The non-transitory, computer-readable medium of claim 16, wherein the physical layer preamble comprises at least a portion of the signature.

18. The non-transitory, computer-readable medium of claim 16, wherein the physical layer preamble comprises a training structure comprising a short training field (L-STF), a long training field (S-STF), and/or a signal field (L-SIG).

19. A computing system comprising:
a wireless transceiver configured to:
transmit multiple wireless data transmission frames; and
receive multiple wireless data reception frames;
a user interface for interacting with a user of the computing system; and
a processor configured to change access to the user interface based on a proximity of the user to the wireless transceiver, wherein the processor is configured to determine the proximity based on channel measurement information in a validated subset of data frames and to select the validated subset of data frames from among the multiple wireless data reception frames based on whether the multiple wireless data reception frames include the signature within the multiple wireless data transmission frames.

20. The system of claim 19, wherein the processor is configured to determine the validated subset of data frames further based on an inconsistency among channel information measurements contained within the multiple wireless data transmission frames.
